(19) United States
(12) Patent Application Publication
(10) Pub. No.: US 2011/0151782 A1
(43) Pub. Date: Jun. 23, 2011

(54) SYSTEM AND METHOD FOR COMMUNICATION WITH HANDS-FREE PROFILE

(76) Inventor: Chun-I SUN, Taipei County (TW)

(21) Appl. No.: 12/858,847

(22) Filed: Aug. 18, 2010

(30) Foreign Application Priority Data
Dec. 18, 2009 (TW) 098143700

(51) Int. Cl. H04B 7/00; H04M 1/00; G10L 15/00

(52) U.S. Cl. 455/41.2; 455/569.1; 704/231; 704/E15.001

(57) ABSTRACT

The present invention relates to a system and a method for communication with hands-free profile. The method includes the steps of: providing illumination devices which microphones and speakers are respectively disposed on; providing a detection mechanism for detecting the position of a specific illumination device corresponding to a position of a user; when a communication device receives an incoming telegram signal: sending a preset ring by the speakers; and transmitting the sound transmitted from the communication device to the speaker of the specific illumination device and transmitting the sound received from the microphone of the specific illumination device to the communication device so that the communication is performed.

This application claims priority of No. 098143700 filed in Taiwan R.O.C. on 2009 Dec. 18 under 35 USC 119, the entire content of which is hereby incorporated by reference.

### BACKGROUND OF THE INVENTION

1. Field of Invention

The invention relates to the technology associated with a kind of home applications, and more particularly to a system and a method for communication with hands-free profile.

2. Related Art

As the personal electronic products changing, the product quality, the multi-functional and the portable requirements are greatly increased. In addition, as the development of the electronic communication, the mobile communication device becomes one of indispensible personal electronic product. multiple functions had been integrated in the same mobile communication device, in addition to the basic call, answer functions and appearance required to compact size, moreover, many additional features had been added. Especially, the hands-free function has been a very popular function.

In the conventional art, there are three methods to implement the hand-free communication. FIG. 1 is a diagram depicting a communication with hand-free profile using mobile communication device according to the conventional art. Referring to FIG. 1, a mobile communication device (cell-phone) 101, a signal line 102 and a headset 103. The hand-free communication is implemented by the headset 103 coupling to the mobile communication device (cell-phone) 101 through the signal line 102. FIG. 2 is a diagram depicting another communication with hand-free profile according to the conventional art. Referring to FIG. 2, a mobile communication device (cell-phone) 201 and a headset 202 is shown in FIG. 2. The difference from FIG. 1 is that the headset 202 is coupled to the mobile communication device 201 through Bluetooth protocol. The third method for implementing the communication with hand-free profile is a built-in hand-free function of the mobile communication device (cell-phone). User can switches the function of cell-phone into the hand-free function so that the volume is amplified by the built-in speaker of the cell-phone. Therefore, user can use the microphone of the cell-phone to perform the communication without using hand.

In the abovementioned first method, since the bundled headset of the cell-phone generally is basic. It causes uncomfortable to ear when the headset is worn for a period. In the second method, the wireless Bluetooth headset 202 need to frequently charge. If user forgets to charge the headset, the hand-free function cannot be performed. In the third method, the drawbacks of the first method and the second method is solved. However, to switch the hand-free function of the mobile communication device (cell-phone) and to answer the cell-phone by self is required. Since the mobile communication service provider generally limits the ringing time period, user may not have enough time to answer the phone call if the distance between user and cell-phone. Thus, the mobile communication service provider would coercively hand up the phone.

### SUMMARY OF THE INVENTION

An object of the invention is to provide a system for communication with hand-free profile to prevent the uncomfortableness caused by the conventional art during communication.

Another object of the invention is to provide a method for communication with hand-free profile. When a user answers a phone call, the user can phone where he/she goes.

To achieve the above-identified or other objects, the invention provides a system for communication with hand-free profile. The system includes a communication device, a plurality of illumination devices and a control circuit. Each of illumination devices respectively comprises a microphone and a speaker. The microphone is disposed on each illumination device for receiving the audio emitted from the opposite of the illumination devices. The speaker is disposed on each illumination device. The control circuit is coupled to the illumination devices and the communication device. When the communication device receives a incoming telegram signal, the control circuit control the speaker to ring a preset ringing. When the microphone of the specific illumination device receives an audio signal emitted from an user opposite to the specific illumination device, the control circuit transmits the audio signal from the communication device to the speaker of the specific illumination device and transmits the audio signal received by the microphone of the specific illumination device to the communication device so that the communication is performed.

The present invention also provides a system integrated an illumination system for communication with hand-free profile. The difference from the mentioned above is that an infrared detector is disposed on each illumination device. The infrared detector is used for detecting a specific range infrared emitted by the opposite user of the illumination devices. When a infrared detector of a specific illumination device receives the specific range infrared emitted from a user who is opposite to the specific illumination device, the control circuit transmits the audio signal from the communication device to the speaker of the specific illumination device, and transmits the audio signal received by the microphone of the specific illumination device to the communication device so that the communication is performed.

The present invention further provides a system integrated an illumination system for communication with hand-free profile. The difference from the mentioned above is that the system can be specifically used for dialing. The system includes a communication device, a plurality of illumination devices and a control circuit. each illumination device respectively comprises a microphone and a speaker. The microphone is disposed on each illumination device for receiving the audio signal emitted from the opposite of the illumination devices. The speaker is respective disposed on each illumination device. The control circuit is coupled to the illumination devices and the communication device. When one of the microphones of the illumination devices receives a audio message emitted by a user, the control circuit transmits the audio message to the communication device to perform a speech recognition to determine whether the audio message is a dialing message. When the audio message is the dialing message, the communication device dials a specific number corresponding to the dialing message and the control circuit transmits a dialing ringing from the communication device to the speakers.

In the system according to the preferred embodiment of the present invention, the control circuit is further used for receiving the audio signal received by the microphones of the illumination devices to perform a speech recognition to further determine a position of a specific illumination device corresponding to a user's position. In addition, the control circuit also can be used for receiving the audio signals received by the microphones of the illumination devices to determine whether the decibels of the audio signals are larger than a preset decibel so that a position of a specific illumination device corresponding to a user's position is determined. Furthermore, in another preferred embodiment, the communication device comprises a mobile phone, a telephone and an internet phone. In addition, the communication device can be coupled to the control circuit through a Bluetooth protocol.

The present invention also provides a method for communication with hand-free profile. The method comprises the steps of: providing a plurality of illumination devices, wherein a microphone and a speaker are respectively disposed on each illumination device; providing a detecting mechanism for detecting a position of a specific illumination device of the illumination devices corresponding to a user's position; when a communication device receives a incoming telegram signal: emitting a preset ringing through the speakers; and transmitting an audio signal outputted from the communication device to the speaker of the specific illumination device and transmitting the audio signal received by the microphone of the specific illumination device to the communication device so that a communication is performed.

The present invention additionally provides a method for communication with hand-free profile. The difference from the mentioned above is that the method is used for dialing. The method comprises the steps of: providing a plurality of illumination devices, wherein a microphone and a speaker are respective disposed on each illumination device; providing a detecting mechanism for detecting a position of a specific illumination device corresponding to a user's position; transmitting a audio message to a communication device to perform a speech recognition to determine whether the audio message is a dialing message when a microphone of one of illumination device receives the audio message emitted by a user, wherein, when the audio message is the dialing message, the method further comprises the steps of: dialing a specific number corresponding to the dialing message through the communication device; and transmitting a dialing ringing outputted from the communication device to the speakers of the illumination device.

In the method according to the preferred embodiment of the present invention, the detecting mechanism includes the following options:

1. determining whether decibels of the audio signals received by the microphones of the illumination devices are larger than a preset decibel;

2. determining whether a specific range infrared opposite to the illumination devices is exist; and/or

3. receiving the audio signal received by the microphones of the illumination devices to perform a speech recognition to determine a position of a specific illumination device of the illumination devices corresponding to a user's position.

The spirit of the invention is to use the indoor illumination device required by interior design to integrated a speaker and microphone and control mechanism so that it can be used for communication with hand-free profile. Thus, the present invention at least comprises the advantages as follow:

1. The headset is unnecessary so that user's ear would not fell uncomfortable.

2. There is no need to charge the hand-free system of the present invention so that the incoming telegram would not be missed.

3. The user can phone where he/she goes. The present invention comprises a detecting mechanism. The user can phone where he/she goes if the illumination devices of the present invention are disposed on the route user pass.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a diagram depicting a communication with hand-free profile using mobile communication device according to the conventional art.

FIG. 2 is a diagram depicting another communication with hand-free profile according to the conventional art.

FIG. 3 is a three-dimensional diagram depicting an illumination device 30 used for the system of the present invention according to a preferred embodiment of the present invention.

FIG. 4 is a bottom view of the illumination device 30 according to a preferred embodiment of the present invention.

FIG. 5 is a diagram depicting a system integrated an illumination system for communication with hand-free profile according to a preferred embodiment of the present invention.

FIG. 6 is another bottom view of the illumination device adapted for the system integrated a illumination system for communication with hand-free profile according to a preferred embodiment of the present invention.

FIG. 7 is another diagram depicting the system for communication with hand-free profile according to a preferred embodiment of the present invention.

FIG. 8 is a diagram depicting a system integrated a illumination system for communication with hand-free profile according to an preferred embodiment of the present invention.

FIG. 9 is a flowchart depicting a method for communication with hand-free profile according to a preferred embodiment of the present invention.

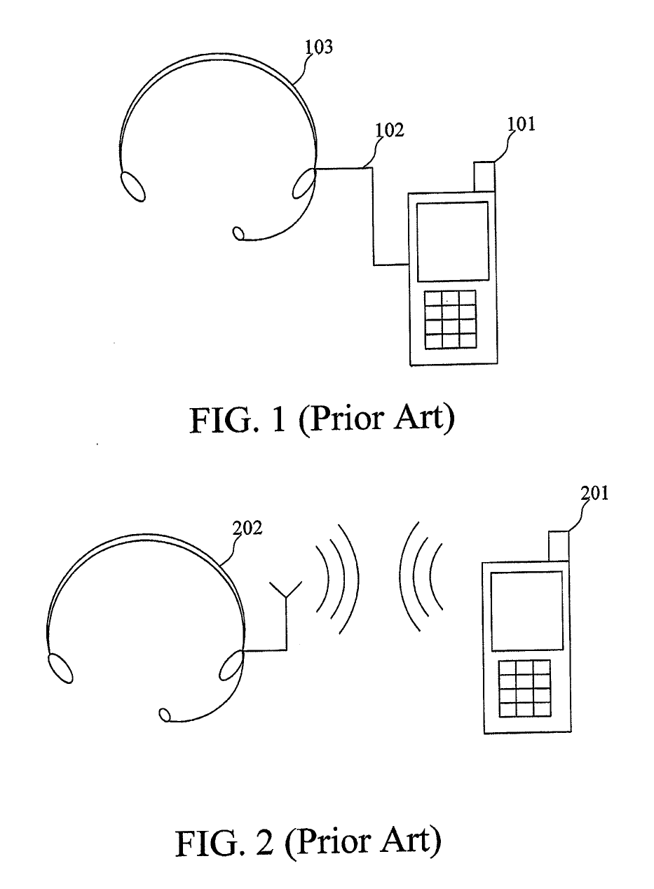

### DETAILED DESCRIPTION OF THE INVENTION

The present invention will be apparent from the following detailed description, which proceeds with reference to the accompanying drawings, wherein the same references relate to the same elements.

### First Embodiment

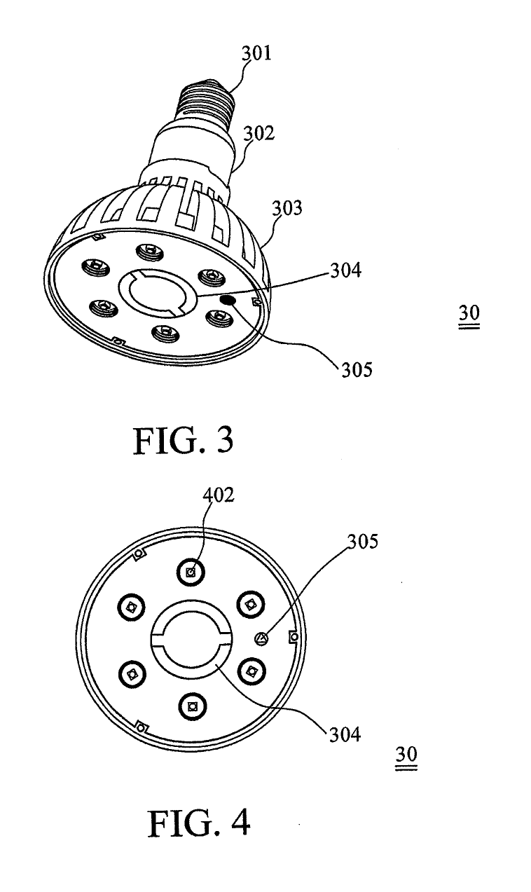

FIG. 3 is a three-dimensional diagram depicting an illumination device 30 used for the system of the present invention according to a preferred embodiment of the present invention. Referring to FIG. 3, the illumination device 30 comprises a lamp cap 301, a lamp body 302, a lamp reflector 303, a speaker 304 and a microphone (not shown in FIG. 3). FIG. 4 is a bottom view of the illumination device 30 according to a preferred embodiment of the present invention. Referring to FIG. 4, the illumination device comprises a speaker 304, a microphone 305 and six light emitting diodes 402.

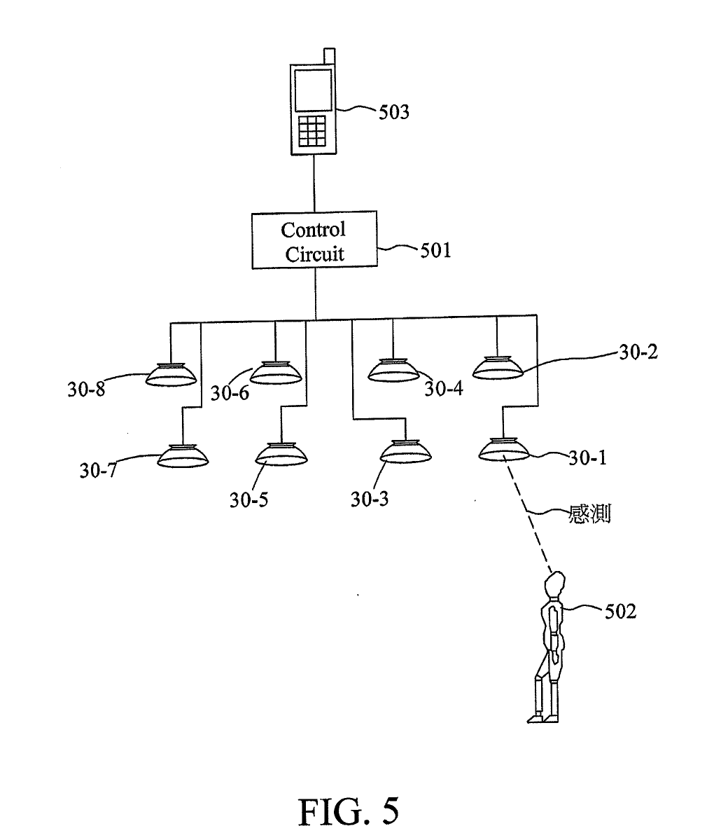

FIG. 5 is a diagram depicting a system integrated an illumination system for communication with hand-free profile according to a preferred embodiment of the present invention. Referring to FIG. 5, the system includes 8 illumination devices 30-1, 30-2, 30-3, 30-4, 30-5, 30-6, 30-7 and 30-8 (as mentioned above) and a control circuit 501. The illumination devices 30-1, 30-2, 30-3, 30-4, 30-5, 30-6, 30-7 and 30-8 are coupled to the control circuit 501. In order to clearly explain the first embodiment of the present invention, a user 502 and a communication device 503 are additionally drawn in FIG. 5. In the first embodiment, the communication device 503 may be a mobile phone, a telephone, or an internet phone, and so forth . . . . In order to conveniently explain the spirit of the present invention, a mobile phone is adopted as an example of the communication device in the first embodiment.

In the first embodiment, the mobile phone (communication device) 503 is coupled to the control circuit 503 through its hands-free headset port. When the mobile phone 503 accepts a incoming telegram, the mobile phone 503 transmits a incoming telegram ringing to the control circuit 501. Next, the control circuit 501 controls the speakers of the illumination devices 30-1, 30-2, 30-3, 30-4, 30-5, 30-6, 30-7 and 30-8 to emit the incoming telegram ringing. Afterward, the user 502 can transmit a command for answering phone call to the control circuit 501 through the nearest microphone of the illumination devices 30-1, 30-2, 30-3, 30-4, 30-5, 30-6, 30-7 and 30-8. In the embodiment, the control circuit 501 receives the audio signal from microphone of the illumination device 30-1 and the decibel of the audio signal is larger than a preset decibel built-in the control circuit 501 so that the command for answering phone call is conducted. Afterward, the control circuit 501 transmits the audio signal outputted from the mobile phone (communication device) 503 to the speaker of the illumination device 30-1 and transmits the audio signal received by the microphone of the illumination device 30-1 to the mobile phone (communication device) 503 so that the communication is performed.

According to the abovementioned first embodiment, it should know that to use the abovementioned system for communication with hand-free profile does not need to wear any headset. In addition, since the user's position can be detected by the microphones of the illumination devices, the user can phone where he/she goes. Moreover, in order to accurately detect, an infrared detector can be additionally disposed on the illumination devices 30-1, 30-2, 30-3, 30-4, 30-5, 30-6, 30-7 and 30-8.

### Second Embodiment

Similarly. Referring to FIG. 5, in the abovementioned embodiment, a user's volume received by the microphones of the illumination devices is adopted for determining a user's position. In the following second embodiment, another method for determining a user's position is adopted for achieving communication with hand-free profile.

When a mobile phone (communication device) 503 accepts an incoming telegram signal, the mobile phone (communication device) 503 transmits an incoming telegram ringing to the control circuit 501. Next, the control circuit 503 controls the illumination devices 30-1, 30-2, 30-3, 30-4, 30-5, 30-6, 30-7 and 30-8 to emit the incoming telegram ringing. Afterward, the user 502 can use his/her speech to transmit a command for answering phone call through the nearest microphone of the illumination devices 30-1, 30-2, 30-3, 30-4, 30-5, 30-6, 30-7 and 30-8. In this embodiment, the control circuit 501 receives the audio signal received by the microphone of the illumination device 30-1 and then the control circuit 501 conducts a speech recognition to compare the eigenvalue of the audio signal with the embedded preset value. When finish comparing and the audio signal of the user 502 is confirmed, the control circuit 503 transmits the audio signal outputted from the mobile phone (communication device) 503 to the speaker of the illumination device 30-1 and transmits the audio signal received by the microphone of the illumination device 30-1 to the mobile phone (communication device) 503 so that a hand-free communication is performed.

### Third Embodiment

In the first and the second embodiments above, a user's audio signal is adopted for determining a user's position. In the following third embodiment, another method for determining a user's position is adopted for achieving communication with hand-free profile.

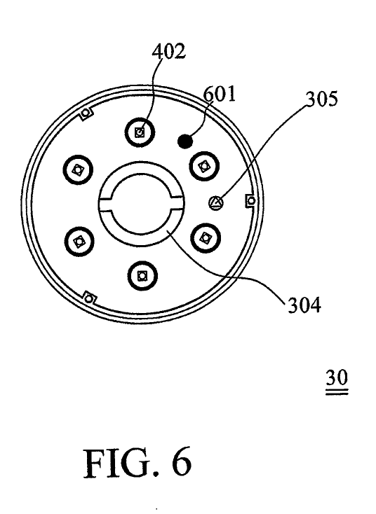

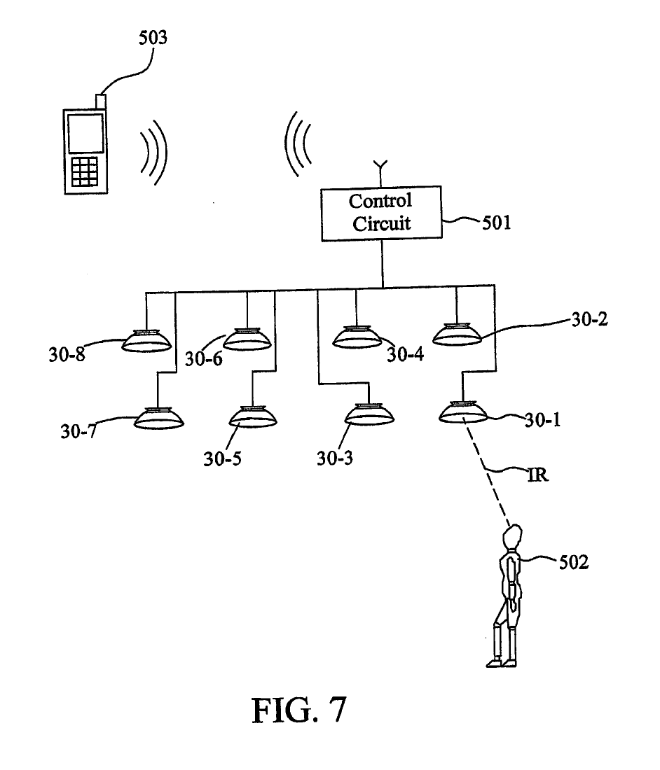

FIG. 6 is another bottom view of the illumination device adapted for the system integrated a illumination system for communication with hand-free profile according to a preferred embodiment of the present invention. Referring to FIG. 6, the illumination device includes a speaker 304, microphone 401, 8 light emitting diodes 402 and an infrared detector 601. In addition, FIG. 7 is another diagram depicting the system for communication with hand-free profile according to a preferred embodiment of the present invention. Referring to FIG. 7, in this embodiment, the illumination device 30 as shown in FIG. 6 is adopted to serve as the illumination devices 30-1, 30-2, 30-3, 30-4, 30-5, 30-6, 30-7 and 30-8. Moreover, the mobile phone (communication device) 503 is coupled to the control circuit 503 through a wireless protocol, such as Bluetooth protocol, ZIGBEE protocol. In order to conveniently explain the third embodiment, Bluetooth protocol is adopted as an example of the wireless protocol.

When the mobile phone (communication device) 503 receives an incoming telegram signal, the mobile phone (communication device) 503 transmits the incoming telegram ringing to the control circuit 501 through Bluetooth protocol. Next, the control circuit 501 controls the speakers of the illumination devices 30-1, 30-2, 30-3, 30-4, 30-5, 30-6, 30-7 and 30-8 to emit the incoming telegram ringing. The user 502 can use his/her speech to transmit a command for answering phone call through the nearest microphone of the illumination devices 30-1, 30-2, 30-3, 30-4, 30-5, 30-6, 30-7 and 30-8. Afterward, the illumination devices 30-1, 30-2, 30-3, 30-4, 30-5, 30-6, 30-7 and 30-8 detect a specific range infrared through their built-in infrared detectors. In this third embodiments, the infrared detector 601 of the illumination device 30-1 detects the body temperature of the user 502, and the control circuit 501 transmits the audio signal outputted from the mobile phone (communication device) 503 to the speaker of the illumination device 30-1 and transmits the audio signal received by the microphone of the illumination device 30-1 to the mobile phone (communication device) 503 so that the hand-free communication is performed.

### Fourth Embodiment

In the abovementioned first, second and third embodiment, a incoming telegram is adopted as an example. In the following embodiment, that a user uses the system of the present invention to dial is adopted as an example.

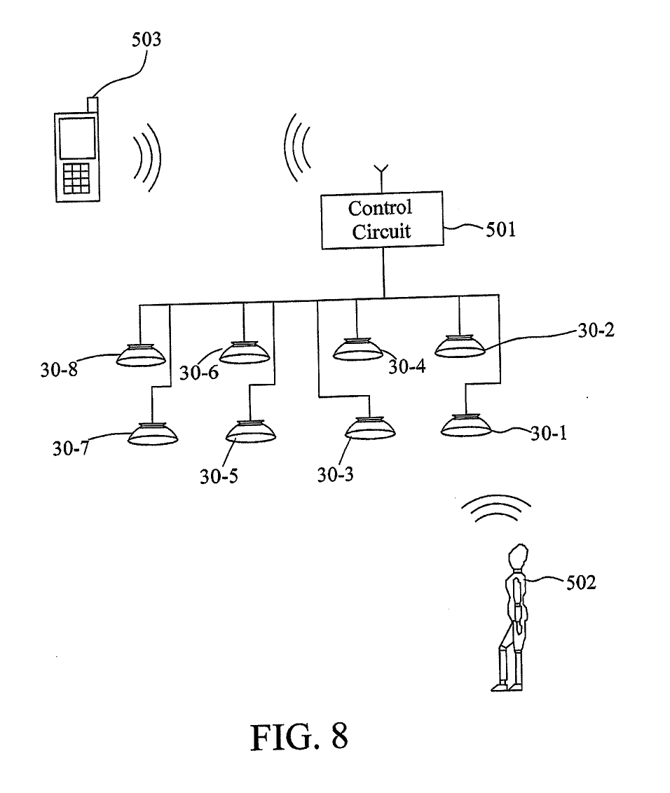

FIG. 8 is a diagram depicting a system integrated a illumination system for communication with hand-free profile according to an preferred embodiment of the present invention. Referring to FIG. 8, in this embodiment, the illumination device 30 as shown in FIG. 6 or the illumination device 30 as shown in FIG. 4 can be adopted to serve as the illumination devices 30-1, 30-2, 30-3, 30-4, 30-5, 30-6, 30-7 and 30-8. In addition, in this embodiment, the mobile phone (communication device) 503 is coupled to the control circuit 501 through a wireless protocol. According to the second embodiment and the third embodiment, people having ordinary skill in the art should know that the present invention does not limit the wired coupling or wireless coupling. The present invention can be implemented when either the mobile phone (communication device) 503 is coupled to the control circuit 501 through a wireless protocol or the mobile phone (communication device) 503 is coupled to the control circuit 501 through a physical connection.

Assume the user 502 walks to a position near the illumination device 30-1, and suddenly wants to call a person A. In addition, the mobile phone (communication device) 503 had stored a voice dialing setting to call the person A. And then, the user speaks a dialing message to the illumination device 30-1, the control circuit 501 receives the audio signal of the dialing message from the microphone of the illumination device 30-1, and transmits the audio signal to the mobile phone (communication device) 503 and enables the voice dialing function of the mobile phone (communication device) 503.

Afterward, the user 502 speaks “dial to person A”. At the meantime, the microphone of the illumination device 30-1 receives the voice “dial to person A” and then transmits the voice “dial to person A” to the control circuit 501. The control circuit 501 transmits the voice to the mobile phone (communication device) 503 to perform a speech recognition.

When the mobile phone (communication device) 503 determines that the voice which the user 502 speaks corresponds to the voice dialing setting to call the person A, the mobile phone (communication device) 503 dials the numbers of person A, and the control circuit 501 transmits the dial ringing outputted from the mobile phone (communication device) 503 to the speakers of the illumination devices 30-1, 30-2, 30-3, 30-4, 30-5, 30-6, 30-7 and 30-8 so that the speakers sounds the dialing ringing.

### Fifth Embodiment

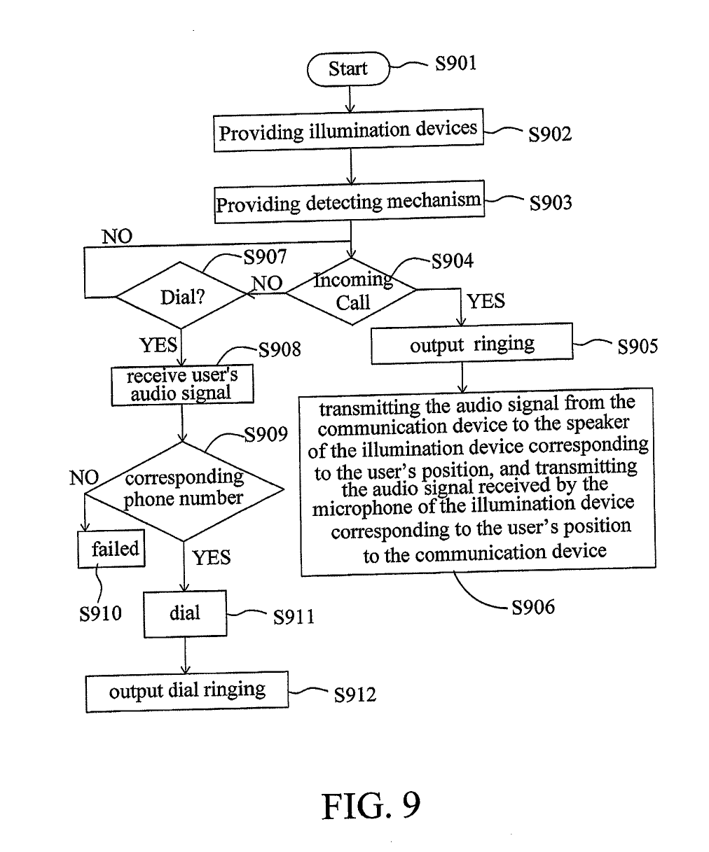

According to the first embodiment, the second embodiment, the third embodiment and the fourth embodiment, a method for communication with hand-free profile is generalized. FIG. 9 is a flowchart depicting a method for communication with hand-free profile according to a preferred embodiment of the present invention. Referring to FIG. 9, the method comprises the steps of:

In step S901, the method starts.

In step S902, a plurality of illumination devices are provided. As shown in FIG. 5, a microphone and a speaker are disposed on the illumination devices 30-1, 30-2, 30-3, 30-4, 30-5, 30-6, 30-7 and 30-8.

In step S903, a detecting mechanism is provided for detecting a position of a specific illumination device of the illumination devices corresponding to the user's position. In the fourth embodiment, there are three options of the abovementioned detecting mechanism as follow:

1. determining whether the decibels of the audio signals received by the microphones of the illumination devices are larger than a preset decibel as the description of the first embodiment;

2. receiving the audio signals received by the microphones of the illumination devices to perform a speech recognition to further determine a position of a specific illumination device of the illumination devices corresponding to a user's position as the description of the second embodiment; and

3. determining a specific range infrared opposite to the illumination devices as the description of the third embodiment.

In step S904, determining whether a incoming telegram signal is receive. When the determination is negative, the step S907 is performed. When the determination is positive, the step S905 is performed.

In step S905, a preset ringing through the speakers is emitted.

In step S906, the audio signal outputted from the communication devices is transmitted to the speaker of the illumination device corresponding to the user's position, and the audio signal received by the microphone of the illumination device corresponding to the user's position is transmitted to the communication device so that the communication is performed.

In step S907, determining whether a dialing message from a user is received. if the determination is negative, the step S904 is performed. When the determination is positive, the step S908 is performed.

In step S908, the audio signal from a user is received again. Afterward, the step S909 is performed.

In step S909, determining whether the audio signal received in step S908 corresponds to a phone number. When the determination is negative, the step S910 is performed. When the determination is positive, the step S911 is performed.

In step S910, a dialing failed message is emitted.

In step S911, a specific number is dialed through the communication device.

In step S912, the dialing ringing outputted from the communication device is transmitted to the speakers so that the speakers sound the dialing ringing.

To sum up, the spirit of the invention is to use the indoor illumination device required by interior design to integrated a speaker and microphone and control mechanism so that it can be used for communication with hand-free profile. Thus, the present invention at least comprises the advantages as follow:

1. The headset is unnecessary so that user's ear would not fell uncomfortable.

2. There is no need to charge the hand-free system of the present invention so that the incoming telegram would not be missed.

3. The user can phone where he/she goes. The present invention comprises a detecting mechanism. The user can phone where he/she, goes if the illumination devices of the present invention are disposed on the route user pass.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A system integrated illumination system for communication with hand-free profile, comprising:
a communication device;
a plurality of illumination devices, wherein the illumination devices comprises:
a plurality of microphones, respectively disposed on the illumination devices, for receiving an audio emitted by an object opposite to the illumination devices; and
a plurality of speakers, respectively disposed on the illumination devices; and
a control circuit, coupled to the illumination devices and the communication device, wherein,
when the communication device receives a incoming telegram signal, the control circuit control the speakers to emit a preset ringing;
when a microphone of a specific illumination device of the illumination devices receives an audio emitted from an user who is opposite to the specific illumination device, the control circuit transmits an audio signal from the communication device to a speaker of the specific illumination device and transmits the audio received from a microphone of the specific illumination to the communication device so that a communication is performed.

2. The system according to claim 1, wherein the illumination devices comprises:
a plurality of infrared detector, respectively disposed on the illumination devices for detecting a specific range infrared emitted from an user opposite to the illumination devices, wherein,
when the infrared detector of an specific illumination device of the illumination device receives the specific range infrared from the user opposite to the specific illumination device, and the communication device receives the incoming telegram signal, the control circuit transmits an audio signal from the communication device to a speaker of the specific illumination device and transmits the audio received from the microphone of the specific illumination to the communication device so that the communication is performed.

3. The system according to claim 1, wherein the control circuit is further used for:
receiving audio signals received by the microphone of the illumination devices to perform a speech recognition to determine a position of the specific illumination device corresponding to a user's position, wherein,
when the communication device receives the incoming telegram signal, the control circuit transmits an audio signal outputted from the communication device to a speaker of the specific illumination device and transmits an audio received by the microphone of the specific illumination to the communication device so that the communication is performed.

4. The system according to claim 1, wherein the control circuit is further used for:
receiving audio signals received by the microphone of the illumination devices and determining whether an decibel of the audio signal is larger than a preset decibel to determine a position of the specific illumination device corresponding to a user's position, wherein,
when the communication device receives the incoming telegram signal, the control circuit transmits an audio signal outputted from the communication device to a speaker of the specific illumination device and transmits an audio signal received by the microphone of the specific illumination to the communication device so that the communication is performed.

5. The system according to claim 1, wherein the communication device comprises a mobile phone, a telephone, a Internet phone.

6. The system according to claim 1, wherein the communication device is coupled to the control circuit through a Bluetooth protocol.

7. A system integrated an illumination system for communication with a hand-free profile, comprising:
a communication device;
a plurality of illumination devices, wherein the illumination devices comprises:
a plurality of microphones, respectively disposed on the illumination devices, for receiving an audio emitted by an object opposite to the illumination devices;
a plurality of infrared detector, respectively disposed on the illumination devices for detecting an specific range infrared emitted from an user opposite to the illumination devices; and
a plurality of speakers, respectively disposed on the illumination devices; and
a control circuit, coupled to the illumination devices and the communication device, wherein,
when the communication device receives a incoming telegram signal, the control circuit control the speakers to emit a preset ringing;
when a infrared detector of a specific illumination device of the illumination devices receives the specific range infrared emitted from an user who is opposite to the specific illumination device, the control circuit transmits an audio signal from the communication device to a speaker of the specific illumination device and transmits the audio received from a microphone of the specific illumination to the communication device so that a communication is performed.

8. The system according to claim 7, wherein the control circuit is further used for:
receiving audio signals from the microphones of the illumination devices and determining whether decibels of the received audio signal are larger than a preset decibel to determine a position of the specific illumination device corresponding to the user's position, wherein,
when a microphone of the specific illumination device of the illumination devices receives an audio signal and the decibel of the audio signal of the microphone of the specific illumination device is larger than the preset decibel, the control circuit transmits an audio signal outputted from the communication device to a speaker of the specific illumination device and transmits the audio received by the microphone of the specific illumination to the communication device so that the communication is performed.

9. The system according to claim 7, wherein the control circuit is further used for:
receiving audio signals received by the microphone of the illumination devices to perform a speech recognition to determine a position of the specific illumination device corresponding to a user's position, wherein,
when the communication device receives the incoming telegram signal, the control circuit transmits an audio signal outputted from the communication device to a speaker of the specific illumination device and transmits an audio signal received by the microphone of the specific illumination to the communication device so that the communication is performed.

10. The system according to claim 7, wherein the communication device comprises a mobile phone, a telephone, a internet phone.

11. The system according to claim 7, wherein the communication device is coupled to the control circuit through a Bluetooth protocol.

12. A method for communication with hand free profile, comprising:
providing a plurality of illumination devices, wherein microphones and speakers are respectively disposed on the illumination devices;
providing a detecting mechanism for detecting a position of a specific illumination device of the illumination device corresponding to an user's position;
when a communication device receives a incoming telegram signal:
emitting a preset ringing through the speakers of the illumination devices; and
transmitting an audio signal of the communication device to a speaker of the specific illumination device and transmitting an audio received from a microphone of the specific illumination device to the communication device so that a communication is performed.

13. The method according to claim 12, wherein the detecting mechanism comprises:
determining whether decibels of audio signals received by the microphones of the illumination device are larger than a preset decibel.

14. The method according to claim 12, wherein the detecting mechanism comprises:
determining whether a specific range infrared opposite to the illumination devices is exist.

15. The method according to claim 12, wherein the detecting mechanism comprises:
receiving audio signals of the illumination signal to perform speech recognition to determine a position of the specific illumination device corresponding to a user's position.

16. The method according to claim 12, wherein the communication device comprises a mobile phone, a telephone, an internet phone.

17. A system integrated an illumination system for communication with hand-free profile, comprises:
a communication device;
a plurality of illumination devices, wherein the illumination devices comprises:
a plurality of microphones, respectively disposed on the illumination devices for receiving an audio emitted by the object opposite to the illumination devices; and
a plurality of speakers, respectively disposed on the illumination devices; and
a control circuit, coupled to the illumination device and the communication device, wherein,
when one of the microphones receives a audio message emitted by a user, the control circuit transmits the audio message to the communication device to perform a speech recognition to determine whether the audio message is a dialing message; and
when the audio message is the dialing message, the communication device dials a specific number corresponding to the dialing message and the control circuit transmits a dialing ringing outputted from the communication device to the speakers so that the speaker emitting the dialing ringring.

18. The system according to claim 17, wherein the illumination devices comprises:
a plurality of infrared detector, respectively disposed on the illumination devices for detecting a specific range infrared emitted from a user who is opposite to the illumination devices, wherein,
when a infrared detector of a specific illumination device of the illumination devices receives the specific range infrared emitted from the user who is opposite to the specific illumination device, and the communication device is during communication, the control circuit transmits an audio signal outputted from the communication device to a speaker of the specific illumination device and transmits an audio signal received by a microphone of the specific illumination device to the communication device.

19. The system according to claim 17, wherein the control circuit is further used for:
receiving audio signals from the microphones of the illumination device to perform a speech recognition to determine a position of a specific illumination device of the illumination devices corresponding to a user's position, wherein,
when the communication device is during communication, the control circuit transmits an audio signal outputted from the communication device to a speaker of a specific illumination device of the illumination devices and transmits an audio signal received by a microphone of the specific illumination device to the communication device so that a communication is performed.

20. The system according to claim 17, wherein the control circuit is further used for:
receiving audio signals from the microphones of the illumination device to determine whether the audio signal are, wherein,
when the communication device is during communication, the control circuit transmits an audio signal outputted from the communication device to a speaker of a specific illumination device of the illumination devices and transmits an audio signal received by an microphone of the specific illumination device to the communication device so that a communication is performed.

21. The system according to claim 17, wherein the communication device comprises a mobile phone, a telephone, a internet phone.

22. The system according to claim 17, wherein the communication device is coupled to the control circuit through a Bluetooth protocol.

23. A method for communication with hand-free profile, comprising:
providing a plurality of illumination devices, wherein a plurality of microphones and a plurality of speakers are respectively disposed on the illumination devices;
providing a detecting mechanism for detecting a position of a specific illumination device of the illumination devices corresponding to a user's position, wherein,
transmitting an audio message to a communication device to perform a speech recognition to determine whether the audio message is a dial message when one of the microphones of the illumination devices receives the audio message emitted from a user;
when the audio message is the dial message:
dialing a specific number corresponding to the dial message through the communication device; and
transmitting a dialing ringing outputted from the communication device to the speakers so that the speakers emits the dialing ringing.

24. The method according to claim 23, wherein the detecting mechanism comprises:
determining decibels of the audio signals received by the microphones of the illumination devices are larger than a preset decibel;

25. The method according to claim 23, wherein the detecting mechanism comprises:
determining whether there is a specific range infrared emitted from the opposite of the illumination devices;

26. The method according to claim 23, wherein the detecting mechanism comprises:
receiving audio signals received by the microphones of the illumination devices to perform a speech recognition to determine a position of a specific illumination device of the illumination devices corresponding to a user's position;

27. The method according to claim 23, wherein the communication device comprises a mobile phone, a telephone, an internet phone.
